(19) United States
(12) Patent Application Publication
(10) Pub. No.: US 2024/0346322 A1
(43) Pub. Date: Oct. 17, 2024

(54) SEMI-SUPERVISED MACHINE LEARNING MODEL FRAMEWORK FOR UNLABELED LEARNING

(71) Applicant: Paypal, Inc., San Jose, CA (US)

(72) Inventors: Mahesh Balan Umaithanu, Chennai (IN); Rohith Srinivaas Mohanakrishnan, Chennai (IN); Venkata Subramanian Selvaraj, Chennai (IN)

(21) Appl. No.: 18/328,514

(22) Filed: Jun. 2, 2023

(30) Foreign Application Priority Data
Apr. 17, 2023 (IN) 202341028061

(51) Int. Cl. G06N 3/0895

(52) U.S. Cl. CPC G06N 3/0895

(57) ABSTRACT

Methods and systems are presented for providing a semi-supervised machine learning framework for training a machine learning model using partly mislabeled training data sets. Using the semi-supervised machine learning framework, an iterative training process is performed on the machine learning model, wherein the training data is being adjusted continuously in each iteration for training the machine learning model. During each iteration, the machine learning model is evaluated based on its ability to identify training data that has been mislabeled. The labeling of identified mislabeled training data is corrected before feeding back to the machine learning model in the next training iteration.

### CROSS REFERENCE TO RELATED APPLICATION

The present invention claims priority to India Provisional Patent Application No. 20/234,1028061, filed Apr. 17, 2023, which is incorporated herein by reference in its entirety.

### BACKGROUND

The present specification generally relates to machine learning models, and more specifically, to a semi-supervised learning framework for training a machine learning model based on partly mislabeled data according to various embodiments of the disclosure.

### Related Art

Machine learning models have been widely used to perform various tasks for different reasons. For example, machine learning models may be used in classifying data (e.g., determining whether a transaction is a legitimate transaction or a fraudulent transaction, determining whether a merchant is a high-value merchant or not, determining whether a user is a high-risk user or not, etc.). To construct a machine learning model, a set of input features that are related to performing a task associated with the machine learning model are identified. In semi-supervised learning, training data that includes attribute values corresponding to the set of input features and labels corresponding to pre-determined classifications may be provided to train the machine learning model. Based on the training data and labels, the machine learning model may learn patterns associated with the training data, and provide predictions based on the learned patterns. For example, new data (e.g., transaction data associated with a new transaction) that corresponds to the set of input features may be provided to the machine learning model, and the machine learning model may perform a prediction for the new data (e.g., classifying the new data) based on the learned patterns.

While a machine learning model can be effective in learning patterns, the accuracy of its prediction can be highly dependent on the quality of training data used to train the machine learning model. When the quality of the training data is low (e.g., when the training data includes mislabeled data sets, etc.), the prediction accuracy of the model may suffer. In certain scenarios, it may be challenging to ensure that all of the training data is correctly labeled, as discussed in more detail below. As such, there is a need for providing a framework for training machine learning models such that the machine learning models can perform predictions accurately (e.g., above an accuracy threshold, etc.) even when the training data includes mislabeled data sets.

### BRIEF DESCRIPTION OF THE FIGURES

FIG. 1 is a block diagram illustrating an electronic transaction system according to an embodiment of the present disclosure;

FIG. 2 illustrates training data that is divided into different groups based on the classification labels according to an embodiment of the present disclosure;

FIG. 3 illustrates a data flow associated with training a machine learning model using the semi-supervised learning framework according to an embodiment of the present disclosure;

FIG. 4 is a flowchart showing a process of training a machine learning model according to an embodiment of the present disclosure;

FIG. 5 illustrates an example neural network that can be used to implement a machine learning model according to an embodiment of the present disclosure; and

FIG. 6 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes methods and systems for providing a semi-supervised learning framework for training machine learning models using an iterative training methodology based on partly mislabeled training data sets. As discussed herein, the accuracy performance of a machine learning model can be highly dependent on the accurate labeling of the training data. When some of the training data is mislabeled, the machine learning model may derive incorrect patterns from the training data during the training phase, which may result in a decrease in prediction accuracy when the trained machine learning model is in operation (e.g., when the trained machine learning model is tasked to perform predictions on new data sets, etc.).

Training data can be mislabeled for different reasons. For example, when the training data is labeled manually by one or more human classifiers, the labeling can be prone to human errors. In another example, an organization may provide electronic transactional services (e.g., login transactions for logging in to various user accounts, data access transactions, electronic payment transactions, search transactions, etc.) for its end user. The organization may assume that every transaction is legitimate unless it is reported otherwise by the corresponding end user. When an end user of the organization reports that a previously conducted transaction corresponds to a fraudulent transaction (e.g., a fraudulent charge to a credit card using stolen credit card information, a login attempt that was conducted by an imitator, an unrecognized account access, etc.), the organization may use that information to label such a transaction as a fraudulent transaction. When no reports were filed within a period of time after a transaction is conducted, the organization may assume that the transaction is not a fraudulent transaction, and label the transaction as such. The organization may generate training data for training a machine learning model configured to classify transactions as fraudulent transactions or non-fraudulent transactions based on the previously labeled transactions.

In this paradigm, the training data associated with the organization may correspond to transactions that are labeled as fraudulent (e.g., based on reports by end users) and transactions that are labeled as non-fraudulent (e.g., transactions without any associated fraud reports filed by end users within the period of time). Since most (or all) of the transactions that are reported by end users as fraudulent transactions are typically fraudulent, the group of transaction data labeled as fraudulent are mostly correctly labeled. However, it has been appreciated by the inventors that at least some of the transaction data labeled as non-fraudulent may be incorrectly labeled. It is because transactions that were not reported as fraudulent within the time period may turn out to be fraudulent, as there are many reasons why fraudulent transactions are not reported or not reported within the time period, such as when the end user was not alerted about the fraudulent transaction, when the end user filed a fraud report after the time period, when the end user resolved the issue with a third-party different from the organization, or other reasons.

As a result, the training data of the organization may include a group of transaction data labeled as non-fraudulent transactions, where at least some of the transaction data in this group is mislabeled. Conventionally, using mislabeled training data to train a machine learning model may adversely affect the accuracy performance of the machine learning model, such that the machine learning model may not be able to perform a task (e.g., classifying transactions) with acceptable accuracy (e.g., having a false positive rate and a false negative rate below a threshold), which can result in additional use of computing resources to address the wrong prediction.

As such, according to various embodiments of the disclosure, a classification system may provide a semi-supervised learning framework for training machine learning models that can reduce or eliminate adverse effects from using mislabeled training data. Under such a semi-supervised learning framework, it is assumed that at least some of the training data is mislabeled. By performing an iterative process of arbitrarily mislabeling various training data sets and training the machine learning model using an objective function (also referred to as a “loss function”) generated based on an F-measure, the machine learning model can be trained to not only derive patterns from the training data based on the labels of the training data, but also detect training data sets that have been mislabeled. Using such an iterative process to train the machine learning model, the accuracy performance of the machine learning model can be improved over other machine learning models that are trained using conventional methods, even when the training data includes mislabeled data.

The classification system may first obtain training data from the organization. The training data may be divided into multiple groups of training data sets, where each group corresponds to a different label (e.g., a different classification). For example, when the machine learning model is configured to perform binary classifications (e.g., classifying transactions into fraudulent transactions or non-fraudulent transactions), the training data may include two groups of training data sets: a first group of training data sets that are labeled with a first classification (e.g., fraudulent transactions) and a second group of training data sets that are labeled with a second classification (e.g., non-fraudulent transactions). In another example, when the machine learning model is configured to classify data sets into four different classifications (e.g., four different risk levels, four different item categories, etc.), the training data may be divided into four corresponding groups of training data sets. Any number of different data set classifications may be used, based on the needs of the system or the machine learning model.

Using the semi-supervised learning framework as disclosed herein, it is assumed by the classification system that at least one group of training data sets includes training data sets that are mislabeled. Using the example discussed above, due to various reasons of under-reporting, the group of training data sets that is labeled as non-fraudulent transactions may include training data sets that correspond to fraudulent transactions. As such, it is desirable for the machine learning model to be trained to not only derive patterns from the training data, but also to identify mislabeled training data from the groups of training data sets.

It is generally difficult to know if the training data includes mislabeled training data sets and which of the training data sets were mislabeled. In order to provide a verifiable way to train the machine learning model to detect mislabeled training data sets, the classification of some embodiments may artificially inject mislabeled training data sets into the training data. In some embodiments, the classification system may first modify the training data to artificially include mislabeled training data sets before using the modified training data to train the machine learning model. The modification to the training data may involve relabeling some of the existing training data. For example, when it is suspected that the second group of training data sets includes mislabeled training data sets, the classification may modify the training data by selecting one or more training data sets from the first group of training data sets, and relabeling the one or more training data sets (e.g., reassigning the one or more training data sets from the first group to the second group). In some embodiments, the one or more training data sets may be selected arbitrarily (e.g., randomly using a randomizer algorithm, etc.). The purpose of relabeling some of the training data sets is to assist the classification system to accurately evaluate the ability of the machine learning model in identifying mislabeled data sets, which will be discussed in detail below.

After modifying the training data, the classification system may train the machine learning model using the modified training data based on an objective function associated with the semi-supervised learning framework. In some embodiments, the machine learning model may be configured and trained to output a classification score based on input data (e.g., data associated with a transaction). The classification scores may be within a range (e.g., 0-1, 1-10, 0-100, etc.), and each score may indicate a predicted classification for a corresponding transaction. For example, the classification system may determine a score threshold, such that the classification system may classify a transaction as a first classification (e.g., fraudulent transaction) when the classification score generated by the machine learning model is above the threshold, and may classify the transaction as a second classification (e.g., non-fraudulent transaction) when the classification score generated by the machine learning model is below the threshold.

In some embodiments, the objective function may be determined based on a within-group output variance and/or a between-group output variance. An output variance is a measure of dispersion that takes into account the spread of all outputs by the machine learning model. As such, the within-group output variance can be calculated based on the outputs (e.g., the classification scores, etc.) from the machine learning model using the data sets within the same group. For example, the within-group output variance can be calculated as a statistical measure (e.g., a spread, a range, a standard deviation, etc.) associated with the outputs of the machine learning model. Conversely, the between-group output variance can be calculated based on the outputs (e.g., the classification scores, etc.) from the machine learning model using the data sets from different groups (e.g., from the first and second groups). In some embodiments, the objective function may be associated with a goal to minimize the within-group output variance and/or to maximize the between-group output variance. In a non-limiting example, the objective function may specify to maximize a ratio between the between-group output variance and the within-group output variance (such ratio will also be referred to as the “pseudo F-measure”).

After training the machine learning model using the modified training data and the objective function, the classification system may evaluate the trained machine learning model's ability to identify mislabeled data sets. In some embodiments, the classification system may evaluate the machine learning model's ability to identify mislabeled data sets based on the outputs produced by the trained machine learning model. For example, the classification system may feed the training data sets from the first group to the trained machine learning model to obtain a first set of outputs, and may feed the training data sets from the second group to the trained machine learning model to obtain a second set of outputs. The classification system may determine whether the machine learning model has successfully identified one or more mislabeled training data sets based on the outputs.

For example, the classification system may analyze the first set of outputs to determine a threshold value (e.g., a maximum output value such as a maximum classification score, a minimum output value such as a minimum classification score, etc.). If the threshold value corresponds to a maximum output value, the classification system may determine the threshold value based on a maximum output within the first set of outputs. On the other hand, if the threshold value corresponds to a minimum output value, the classification system may determine the threshold value based on a minimum output within the first set of outputs.

The classification system may then analyze the second set of outputs to determine whether the machine learning model has identified any training data sets within the second group that are mislabeled based on the threshold output value. For example, when the threshold value corresponds to a maximum value, the classification system may determine that the machine learning model has identified a training data set within the second group as mislabeled when the output associated with the training data set is below the threshold value. When the threshold value corresponds to a minimum value, the classification system may determine that the machine learning model has identified a training data set within the second group as mislabeled when the output associated with the training data set exceeds the threshold value. In some embodiments. the one or more training data sets that are identified as mislabeled by the machine learning model may be part of the relabeled data sets from the first group (part of the data sets that were reassigned from the first group to the second group by the classification system prior to the training of the machine learning model). After identifying the one or more training data sets that have been mislabeled, the classification system may relabel the one or more mislabeled data sets to the correct label (e.g., from the second classification to the first classification).

In some embodiments, the classification system may re-train the machine learning model using the newly modified training data (after relabeling the one or more data sets that have been identified by the machine learning model as mislabeled) in an iterative process. For example, the classification system may use the newly modified training data to re-train the machine learning model. In some embodiments, the re-training of the machine learning model is also performed using the objective function (e.g., having a goal of maximizing the pseudo F-measure, etc.). Since the newly modified training data includes training data that is more accurately labeled than the training data used in the previous iteration (e.g., some of the mislabeled training data sets have been identified and relabeled, etc.), the re-training of the machine learning model using the newly modified training data would improve the accuracy performance of the machine learning model. In some embodiments, the re-training of the machine learning model using the newly modified training data may also improve the machine learning model's ability to detect other mislabeled data sets.

As such, after re-training the machine learning model, the classification system may again evaluate the machine learning model's ability to detect (e.g., identify) mislabeled data sets. Similar to the previous iteration, the classification system may provide the training data sets from the first group (including the relabeled training data sets from the previous iteration) to the re-trained machine learning model to obtain a first set of outputs, and may feed the training data sets from the second group (excluding the relabeled training data sets from the previous iteration) to the re-trained machine learning model to obtain a second set of outputs. The classification system may analyze the first set of outputs to determine a threshold value (e.g., a maximum output value, a minimum output value, etc.). The classification system may then analyze the second set of outputs to determine whether the re-trained machine learning model has identified any additional training data sets within the second group that are mislabeled based on the threshold value.

For example, when the threshold value corresponds to a maximum value, the classification system may determine that the machine learning model has identified a training data set within the second group as mislabeled when the output associated with the training data set is below the threshold value. When the threshold value corresponds to a minimum value, the classification system may determine that the machine learning model has identified a training data set within the second group as mislabeled when the output associated with the training data set exceeds the threshold value. After identifying the one or more training data sets that have been mislabeled, the classification system may relabel the one or more mislabeled data sets to the correct label (e.g., from the second classification to the first classification).

In some embodiments, the classification system may also calculate a pseudo F-measure for the re-trained machine learning model based on the outputs produced by the re-trained machine learning model. The classification system may compare the pseudo F-measure calculated for the machine learning model during the current iteration against the pseudo F-measure calculated for machine learning model during the previous iteration. As the performance of the machine learning model improves in each iteration, the pseudo F-measure calculated for the machine learning model would also increase to reflect the improvement.

In some embodiments, the classification system may use the pseudo F-measure for indicating when the iterative training of the machine learning model is complete. For example, the classification system may determine to stop the iterative process of training the machine learning model when the increase of the pseudo F-measure (from the previous iteration to the current iteration) is below a threshold, indicating a lack of substantive improvement to the machine learning model. As such, the classification system may monitor the changes of the pseudo F-measure in each iteration, and may abort the iterative process of training the machine learning model when the difference of pseudo F-measures between the consecutive iterations is below the threshold.

In a scenario where the increase of the pseudo F-measure exceeds the threshold (indicating a substantial improvement in the machine learning model's ability to detect mislabeled data sets) but no mislabeled data sets have been identified based on the threshold value, the classification system of some embodiments may adjust the threshold value and determine if any mislabeled data sets can be identified based on the adjusted threshold value. For example, if the threshold value corresponds to a maximum output value, the classification system may increase the threshold value (e.g., by 5%, by 10%, etc.). If the threshold value corresponds to a minimum output value, the classification system may reduce the threshold value (e.g., by 5%, by 10%, etc.). In some embodiments, the classification system may determine the amount of adjustment to the threshold value based on the amount of increase in the F-measure. For example, the classification system may determine the amount of adjustment to the threshold value as a percentage (e.g., 80%, 100%, 120%, etc.) of the increase in the F-measure. In some embodiments, the classification system may continue to adjust the threshold value until at least one mislabeled data set is identified.

Using this iterative training process under the semi-supervised machine learning framework, the machine learning model can be trained to accurately classify data sets even though the training data includes mislabeled training data sets. As such, in the presence of mislabeled training data, the machine learning model can be trained to perform the classification task more accurately using the semi-supervised learning framework as disclosed herein than using conventional machine learning model training methods.

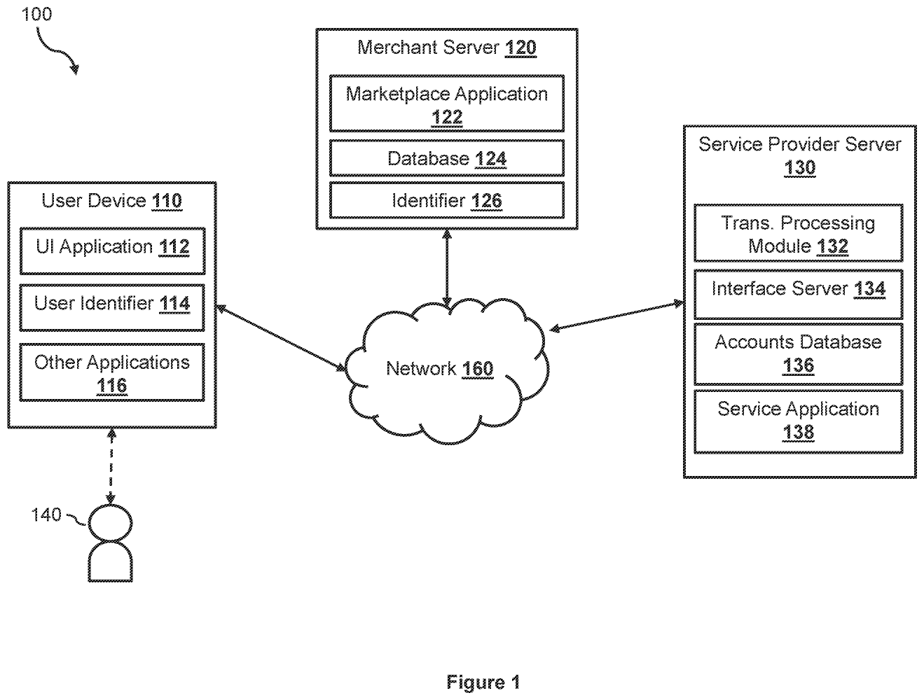

FIG. 1 illustrates an electronic transaction system 100, within which the classification system may be implemented according to one embodiment of the disclosure. The electronic transaction system 100 includes a service provider server 130, a merchant server 120, and a user device 110, that may be communicatively coupled with each other via a network 160. The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The user device 110, in one embodiment, may be utilized by a user 140 to interact with the merchant server 120 and/or the service provider server 130 over the network 160. For example, the user 140 may use the user device 110 to conduct an online purchase transaction with the merchant server 120 via websites hosted by, or mobile applications associated with, the merchant server 120 respectively. The user 140 may also log in to a user account to access account services or conduct electronic transactions (e.g., account transfers or payments) with the service provider server 130. The user device 110, in various embodiments, may be implemented using any appropriate combination of hardware and/or software configured for wired and/or wireless communication over the network 160. In various implementations, the user device 110 may include at least one of a wireless cellular phone, wearable computing device, PC, laptop, etc.

The user device 110, in one embodiment, includes a user interface (UI) application 112 (e.g., a web browser, a mobile payment application, etc.), which may be utilized by the user 140 to interact with the merchant server 120 and/or the service provider server 130 over the network 160. In one implementation, the user interface application 112 includes a software program (e.g., a mobile application) that provides a graphical user interface (GUI) for the user 140 to interface and communicate with the service provider server 130 and/or the merchant server 120 via the network 160. In another implementation, the user interface application 112 includes a browser module that provides a network interface to browse information available over the network 160. For example, the user interface application 112 may be implemented, in part, as a web browser to view information available over the network 160. Thus, the user 140 may use the user interface application 112 to initiate electronic transactions with the merchant server 120 and/or the service provider server 130.

The user device 110, in various embodiments, may include other applications 116 as may be desired in one or more embodiments of the present disclosure to provide additional features available to the user 140. In one example, such other applications 116 may include security applications for implementing client-side security features, programmatic client applications for interfacing with appropriate application programming interfaces (APIs) over the network 160, and/or various other types of generally known programs and/or software applications. In still other examples, the other applications 116 may interface with the user interface application 112 for improved efficiency and convenience.

The user device 110, in one embodiment, may include at least one identifier 114, which may be implemented, for example, as operating system registry entries, cookies associated with the user interface application 112, identifiers associated with hardware of the user device 110 (e.g., a media control access (MAC) address), or various other appropriate identifiers. In various implementations, the identifier 114 may be passed with a user login request to the service provider server 130 via the network 160, and the identifier 114 may be used by the service provider server 130 to associate the user with a particular user account (e.g., and a particular profile).

In various implementations, the user 140 is able to input data and information into an input component (e.g., a keyboard) of the user device 110. For example, the user 140 may use the input component to interact with the UI application 112 (e.g., to add a new funding account, to perform an electronic purchase transaction with a merchant associated with the merchant server 120, to provide information associated with the new funding account, to initiate an electronic payment transaction with the service provider server 130, to apply for a financial product through the service provider server 130, to access data associated with the service provider server 130, etc.).

While only one user device 110 is shown in FIG. 1, it has been contemplated that multiple user devices, each associated with a different user, may be connected to the merchant server 120 and the service provider server 130 via the network 160.

The merchant server 120, in various embodiments, may be maintained by a business entity (or in some cases, by a partner of a business entity that processes transactions on behalf of business entity). Examples of business entities include merchants, resource information providers, utility providers, real estate management providers, social networking platforms, etc., which offer various items for purchase and process payments for the purchases. The merchant server 120 may include a merchant database 124 for identifying available items or services, which may be made available to the user device 110 for viewing and purchase by the user.

The merchant server 120, in one embodiment, may include a marketplace application 122, which may be configured to provide information over the network 160 to the user interface application 112 of the user device 110. In one embodiment, the marketplace application 122 may include a web server that hosts a merchant website for the merchant. For example, the user 140 of the user device 110 may interact with the marketplace application 122 through the user interface application 112 over the network 160 to search and view various items or services available for purchase in the merchant database 124. The merchant server 120, in one embodiment, may include at least one merchant identifier 126, which may be included as part of the one or more items or services made available for purchase so that, e.g., particular items are associated with the particular merchants. In one implementation, the merchant identifier 126 may include one or more attributes and/or parameters related to the merchant, such as business and banking information. The merchant identifier 126 may include attributes related to the merchant server 120, such as identification information (e.g., a serial number, a location address, GPS coordinates, a network identification number, etc.).

While only one merchant server 120 is shown in FIG. 1, it has been contemplated that multiple merchant servers, each associated with a different merchant, may be connected to the user device 110 and the service provider server 130 via the network 160.

The service provider server 130, in one embodiment, may be maintained by a transaction processing entity or an online service provider, which may provide processing for electronic transactions between the user 140 of user device 110 and one or more merchants. As such, the service provider server 130 may include a service application 138, which may be adapted to interact with the user device 110 and/or the merchant server 120 over the network 160 to facilitate the electronic transactions (e.g., electronic payment transactions, data access transactions, etc.) among users and merchants processed by the service provider server 130. In one example, the service provider server 130 may be provided by PayPal®, Inc., of San Jose, California, USA, and/or one or more service entities or a respective intermediary that May provide multiple point of sale devices at various locations to facilitate transaction routings between merchants and, for example, service entities.

In some embodiments, the service application 138 may include a payment processing application (not shown) for processing purchases and/or payments for electronic transactions between a user and a merchant or between any two entities. In one implementation, the payment processing application assists with resolving electronic transactions through validation, delivery, and settlement. As such, the payment processing application settles indebtedness between a user and a merchant, wherein accounts may be directly and/or automatically debited and/or credited of monetary funds in a manner as accepted by the banking industry.

The service provider server 130 may also include an interface server 134 that is configured to serve content (e.g., web content) to users and interact with users. For example, the interface server 134 may include a web server configured to serve web content in response to HTTP requests. In another example, the interface server 134 may include an application server configured to interact with a corresponding application (e.g., a service provider mobile application) installed on the user device 110 via one or more protocols (e.g., RESTAPI, SOAP, etc.). As such, the interface server 134 may include pre-generated electronic content ready to be served to users. For example, the interface server 134 may store a log-in page and is configured to serve the log-in page to users for logging into user accounts of the users to access various service provided by the service provider server 130. The interface server 134 may also include other electronic pages associated with the different services (e.g., electronic transaction services, etc.) offered by the service provider server 130. As a result, a user (e.g., the user 140 or a merchant associated with the merchant server 120, etc.) may access a user account associated with the user and access various services offered by the service provider server 130, by generating HTTP requests directed at the service provider server 130.

The service provider server 130, in one embodiment, may be configured to maintain one or more user accounts and merchant accounts in an accounts database 136, each of which may be associated with a profile and may include account information associated with one or more individual users (e.g., the user 140 associated with user device 110) and merchants. For example, account information may include private financial information of users and merchants, such as one or more account numbers, passwords, credit card information, banking information, digital wallets used, or other types of financial information, transaction history, Internet Protocol (IP) addresses, device information associated with the user account. In certain embodiments, account information also includes user purchase profile information such as account funding options and payment options associated with the user, payment information, receipts, and other information collected in response to completed funding and/or payment transactions.

In one implementation, a user may have identity attributes stored with the service provider server 130, and the user may have credentials to authenticate or verify identity with the service provider server 130. User attributes may include personal information, banking information and/or funding sources. In various aspects, the user attributes may be passed to the service provider server 130 as part of a login, search, selection, purchase, and/or payment request, and the user attributes may be utilized by the service provider server 130 to associate the user with one or more particular user accounts maintained by the service provider server 130 and used to determine the authenticity of a request from a user device.

In various embodiments, the service provider server 130 also includes a transaction processing module 132 that implements the classification system as discussed herein. The transaction processing module 132 may be configured to process transaction requests received from the user device 110 and/or the merchant server 120 via the interface server 134. In some embodiments, depending on the type of transaction requests received via the interface server 134 (e.g., a login transaction, a data access transaction, a payment transaction, etc.), the transaction processing module 132 may use different machine learning models to perform different tasks associated with the transaction request. For example, the transaction processing module 132 may use various machine learning models to analyze different aspects of the transaction request (e.g., a fraudulent transaction risk, a chargeback risk, a recommendation based on the request, etc.). The machine learning models may produce outputs that classify a transaction (e.g., a fraudulent transaction, a non-fraudulent transaction, etc.) or indicate an identity of a product or service to be recommended to a user. The transaction processing module 132 may then perform an action for the transaction request based on the outputs. For example, the transaction processing module 132 may determine to authorize the transaction request (e.g., by using the service applications 138 to process a payment transaction, enabling a user to access a user account, etc.) when the transaction is classified as a non-fraudulent transaction, and may deny the transaction request when the transaction is classified as a fraudulent transaction.

In order to configure and train these machine learning models to perform their respective tasks, the transaction processing module 132 may obtain (or generate) training data based on previously conducted and/or processed transactions. For example, for a machine learning model that is configured to classify transactions into two different classifications (e.g., fraudulent transactions and non-fraudulent transactions), the transaction processing module 132 may access, from the accounts database 136, previously conducted transactions, and label the transactions as either fraudulent or non-fraudulent. In some embodiments, the transaction processing module 132 may label the transactions based on reports (or lack of reports) from the end users. For example, since there is no simple method to verify whether a transaction is fraudulent or non-fraudulent, the transaction processing module 132 may assume all transactions conducted are non-fraudulent unless it has been reported otherwise by a corresponding end user (e.g., an end user reporting that the transaction was not authorized, etc.). The transaction processing module 132 may then label transactions that are associated with fraud reports by end users as fraudulent transactions, and may label transactions that are not associated with fraud reports (e.g., no fraud reports were submitted by end users within a time period from the transactions) as non-fraudulent.

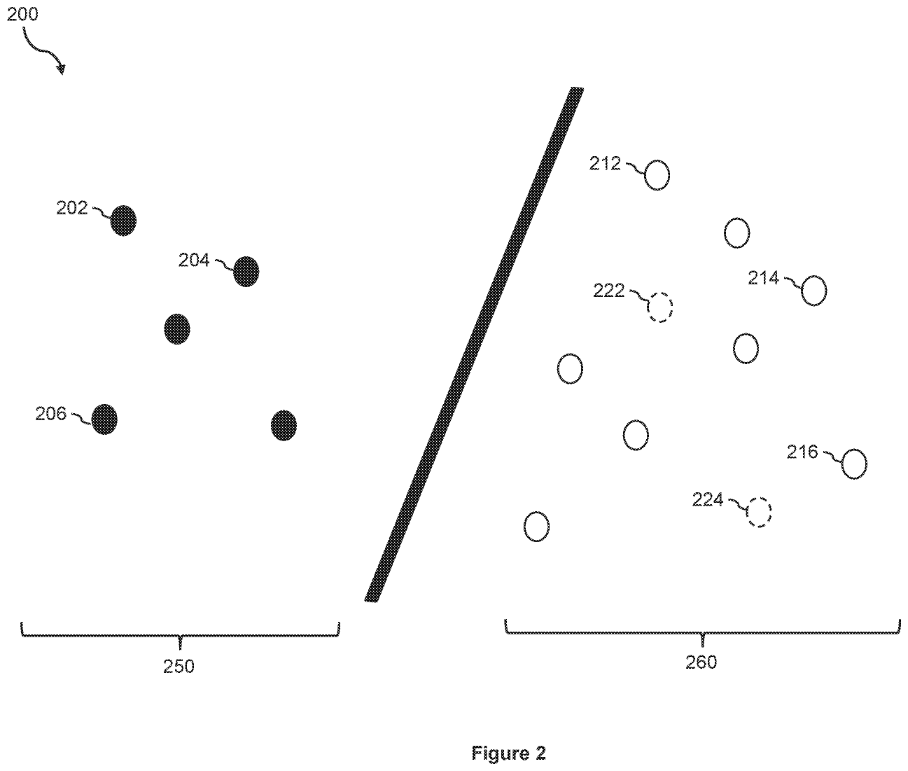

FIG. 2 illustrates a diagram 200 showing transaction data that can be used as training data for training the machine learning model to classify transactions. As shown, since the transactions can be classified as either fraudulent transactions or non-fraudulent transactions, the training data is divided into two groups: a group 250 associated with transactions that are labeled as fraudulent transactions (as indicated by solid black icons, such as transactions 202, 204, and 206, etc.) and a group 260 associated with transactions that are labeled as non-fraudulent transactions (as indicated by solid white icons, such as transactions 212, 214, 216, 222, and 224, etc.). However, as discussed herein, training data can be mislabeled for different reasons. In this example where the transactions are labeled based on the existence of reports from end users, at least some of the transactions labeled as non-fraudulent within the group 260 may be incorrectly labeled. It is because transactions that were not reported as fraudulent within the time period may turn out to be fraudulent, as there are many reasons why fraudulent transactions are not reported, such as when the end user was not alerted about the fraudulent transaction, when the end user filed a fraud report after the time period, when the end user resolved the issue with a third-party different from the organization, or other reasons. As such, the group 260 may include transactions, such as transactions 222 and 224 as indicated by icons having broken-line borders, that are mislabeled (incorrectly labeled).

Since a machine learning model is configured to learn patterns based on the labeling of the training data, using training data that is at last partially mislabeled to train a machine learning model may adversely affect the accuracy performance of the machine learning model, such that the machine learning model may not be able to perform a task (e.g., classifying transactions) with acceptable accuracy (e.g., having a false positive rate and a false negative rate below a threshold). As such, the transaction processing module 132 may use the semi-supervised learning framework as disclosed herein to train the machine learning models, such that the accuracy performance of the machine learning models can be improved even in the presence of mislabeled training data.

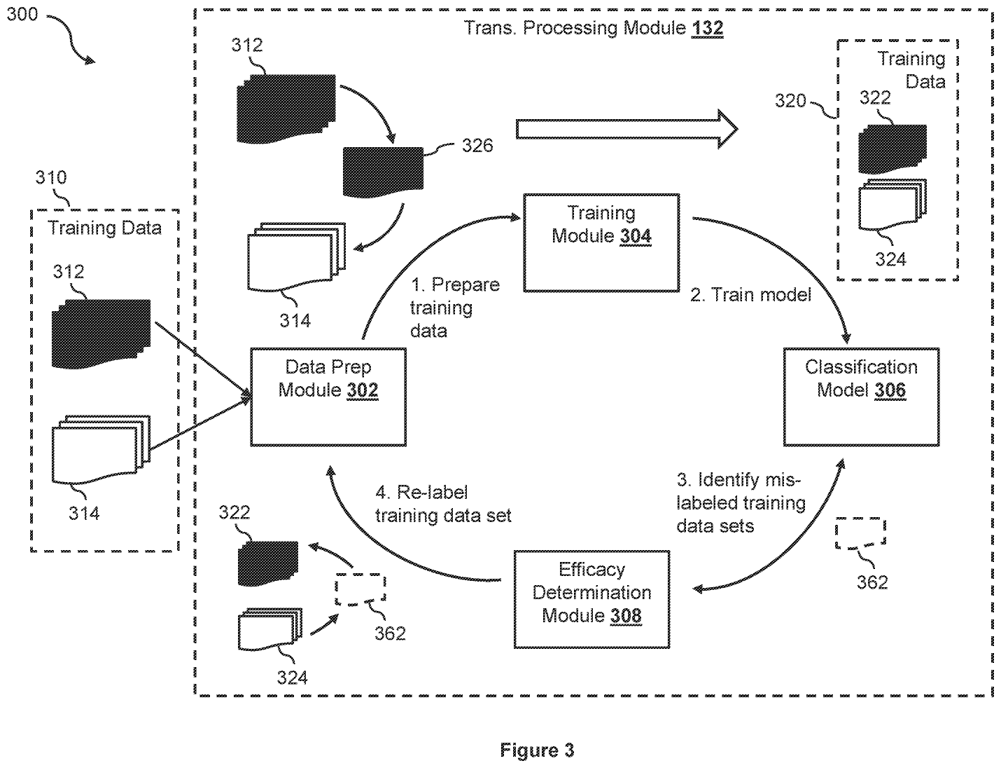

FIG. 3 is a block diagram illustrating the transaction processing module 132 using the semi-supervised learning framework to train a machine learning model according to various embodiments of the disclosure. As shown in FIG. 3, the transaction processing module 132 includes a data preparation module 302, a training module 304, a classification model 306, and an efficacy determination module 308. In some embodiments, the classification model 306 may correspond to a machine learning model (e.g., an artificial neural network, a gradient boosting tree, a transformer, etc.) configured to perform a task (e.g., classifying transactions, generating a product recommendation, classifying users, etc.). The classification model 306 may be configured to accept input values corresponding to a set of input features related to performing the task. For example, when the classification model 306 is configured to classify transactions as either fraudulent transactions or non-fraudulent transactions, the set of input features may include features such as a location of a transaction, an amount associated with the transaction, device attributes of a device (e.g., a device type, a screen resolution, a processor type, a browser type, a network address, etc.) used by a user or a merchant to conduct the transaction, a merchandise category associated with a product being purchased in the transaction, etc.

In order to train the classification model 306 using the semi-supervised learning framework as disclosed herein, the data preparation module 302 may obtain (or generate) training data 310. The training data 310 may be obtained from the accounts database 136 (or generated based on the data in the accounts database 136), and may correspond to different transactions that have been processed by the transaction processing module 132 (or other modules of the service provider server 130) in the past. As such, the training data 310 may include different training data sets, where each training data set in the training data 310 corresponds to a distinct transaction (e.g., a previously processed transaction) and is associated with a label indicating a fraudulent classification or a non-fraudulent classification. Each training data set may also include at least a set of attribute values associated with the corresponding transaction and correspond to the set of input features for the classification model 306.

The training data 310 may be labeled based on the determined classifications of the previously processed transactions. In some embodiments, after obtaining the training data 310. data preparation module 302 may divide the training data 310 into groups according to the labels. In the example where the training data corresponds to previously processed transactions that are classified as either fraudulent transactions or non-fraudulent transactions, the data preparation module 302 may divide the training data 310 into two groups (e.g., a group 312 associated with fraudulent transactions and a group 314 associated with non-fraudulent transactions). The group 312 includes different training data sets, where each training data set in the group 312 is labeled with the fraudulent transaction classification. Similarly, the group 314 also includes different training data sets. Each training data set in the group 314 is labeled with the non-fraudulent transaction classification.

As discussed herein, some of the training data sets within one or more of the groups 312 and 314 may be mislabeled for a variety of reasons. As such, under the semi-supervised learning framework, the transaction processing module 132 may be configured to use an iterative training process to train the classification model 306 such that the classification model 306 can identify mislabeled data sets. To perform the iterative training process under the semi-supervised machine learning framework, the data preparation module 302 may first modify the training data 310 to generate modified training data 320 before using the modified training data 320 to train the classification model 306. The modification may include artificially injecting mislabeled data into the training data 310. For example, the data preparation module 302 may select one or more training data sets 326 from the group 312, and artificially relabel the one or more training data sets 326 from the fraudulent classification to the non-fraudulent classification. As a result of the relabeling, the one or more training data sets 326 is removed from the group 312, and added to the group 314.

Due to the nature of the classification task, the amount of training data sets in the groups 312 and 314 may not be balanced. That is, it is inevitable that one group may include substantially more training data sets than the other group. For example, since the majority of the transactions processed by the service provider serve 130 are classified as non-fraudulent transactions, the group 314 associated with non-fraudulent transactions may include substantially more training data sets than the group 312. As such, in some embodiments, the modification performed on the training data 310 may also include balancing the groups 312 and 314 such that each of the groups 312 and 314 may include substantially (e.g., within 10% difference, within 5% difference, etc.) the same amount of training data sets. Using a balanced set of training data (e.g., when the amounts of training data associated with different labels or classifications are substantially equal) to train the classification model 306 may further improve the accuracy performance of the classification model 306 in performing classification tasks, especially for classifying data sets that are associated with the under-represented classification (e.g., the fraudulent classification). In some embodiments, the data preparation module 302 may identify an under-represented group (e.g., the group that includes the least number of training data sets). In this example, the group 312 associated with the fraudulent classification may be the under-represented group. The data preparation module 302 may then select a subset of training data sets from the group 314 to match the number of training data sets in the group 312 such that the new group 322 (corresponding to the group 312) will have substantially the same amount of training data sets as the new group 324 (corresponding to the group 314).

For example, the training data 310 may include a total of one thousand training data sets, among which 400 of them are labeled as fraudulent (belong to the group 312) and 600 of them are labeled as non-fraudulent (belong to the group 314). The data preparation module 302 may select (e.g., randomly select) one hundred training data sets 326 from the group 312, and relabel them as non-fraudulent. Thus, the one hundred training data sets 326 are transferred from the group 312 to the group 314. After the transfer, the group 312 includes only three hundred training data sets. Thus, to generate the modified training data 320, the data preparation module 302 may use the entire three hundred training data sets from the group 312 to generate the modified group 322, and select (e.g., randomly select) three hundred training data sets from the group 314 to generate the modified group 324. The groups 322 and 324 form the modified training data 320.

In some embodiments, the training module 304 may use the modified training data 320 to train the classification module 306 based on an objective function that enables the classification module 316 to identify mislabeled training data set within the training data 320. In some embodiments, the objective function may be determined based on a within-group output variance and/or a between-group output variance. An output variance is a measure of dispersion that takes into account the spread of all outputs by the classification model 306. As such, the within-group output variance can be calculated based on the outputs from the classification model 306 using the data sets within the same group (e.g., training data sets from the group 322 or the training data sets from the group 324, etc.). Conversely, the between-group output variance can be calculated based on the outputs from the machine learning model using the data sets from different groups (e.g., a data set from the group 322 and another data set from the group 324, etc.). In some embodiments, the objective function may be associated with a goal to minimize the within-group output variance and/or to maximize the between-group output variance. In a non-limiting example, the objective function may specify to maximize a ratio between the between-group output variance and the within-group output variance (also referred to as the “pseudo F-measure”).

After training the classification model 306 using the modified training data 320 and the objective function, the efficacy determination module 308 may evaluate the ability of the trained classification model 306 to identify mislabeled data sets. In some embodiments, the efficacy determination module 308 may evaluate the ability of the classification model 306 to identify mislabeled data sets based on the outputs produced by the trained classification model 306. For example, the efficacy determination module 308 may feed the training data sets from the group 322 to the trained classification model 306 to obtain a first set of outputs, and may feed the training data sets from the group 324 to the trained classification model 306 to obtain a second set of outputs. The efficacy determination module 308 may determine whether the classification model 306 has identified any mislabeled training data within the modified training data 320 based on the outputs.

In some embodiments, the efficacy determination module 308 may analyze the first set of outputs to determine a threshold value. The threshold value may correspond to a maximum output value or a minimum output value produced by the classification model 306 when classifying the training data sets from the group 322. The efficacy determination module 308 may then analyze the second set of outputs to determine whether the classification model 306 has identified any training data sets within the group 324 that are mislabeled based on the threshold output value. For example, when the threshold value corresponds to a maximum value, the efficacy determination module 308 may review the output values generated by the classification model 306 based on the training data sets from the group 324, and determine if any of the output values falls below the threshold value. The efficacy determination module 308 may determine that any training data sets (e.g., a training data set 362) having associated output values that fall below the threshold value are mislabeled. Similarly, if the threshold value corresponds to a minimum value, the efficacy determination module 308 may review the output values generated by the classification model 306 based on the training data sets from the group 324, and determine if any of the output values exceed the threshold. The efficacy determination module 308 may determine that any training data sets (e.g., the training data set 362) having associated output values that exceed the threshold value are mislabeled.

In some embodiments, the training data set 362 identified as mislabeled by the classification model 306 based on the threshold value may be part of the one or more training data sets 326 that were relabeled by the data preparation module 302. After identifying the mislabeled training data set 362, the data preparation module 302 may relabel the mislabeled training data set 362 to the correct label (e.g., from the non-fraudulent classification to the fraudulent classification). As a result, the training data set 362 is moved from the group 324 to the group 322.

In some embodiments, the transaction processing module 132 may re-train the classification model 306 in an iterative process. As such, the data preparation module 302 may prepare the modified training data 320 for use in training the classification model 306 in the next iteration. In some embodiments, after relabeling the mislabeled training data set 362, the modified training data 320 may not be balanced anymore. Using the example illustrated above where each of the group 322 and the group 324 includes three hundred training data sets prior to the evaluation of the classification model 306, if the mislabeled training data sets 362 includes ten training data sets, the ten training data sets from the group 324 would have been moved to the group 322. As a result, the group 322 now includes three hundred and ten training data sets, and the group 324 now includes only two hundred and ninety training data sets. To re-balance the two groups of training data sets, the data preparation module 302 may modify the group 324 such that the group 324 includes substantially the same number of training data sets as the group 322 (e.g., three hundred and ten training data sets). In some embodiments, the data preparation module 302 may simply add twenty training data sets from the group 314 to the group 324. In other embodiments, the data preparation module 302 may randomly select three hundred and ten training data sets from the group 314 to generate a new group 324. This way, the training data 320 used to re-train the classification model 306 may be different in each iteration, which would further improve the accuracy performance of the classification model 306.

The training module 304 may then use the newly modified training data 320 to re-train the classification model 306. In some embodiments, the re-training of the classification model 306 is also performed using the same objective function used in the previous iteration. Since the newly modified training data 320 includes training data that is more accurately labeled than the training data used in the previous iteration (e.g., some of the mislabeled training data sets, such as the mislabeled training data set 362, have been identified and relabeled, etc.), the re-training of the classification model 306 using the newly modified training data would improve the accuracy performance of the classification model 306. In some embodiments, the re-training of the classification model using the newly modified training data may also improve the ability of the classification model 306 to detect other mislabeled data sets.

As such, after re-training the classification model 306, the efficacy determination module 308 may again evaluate the ability of the classification model 306 to detect (e.g., identify) mislabeled data sets. Similar to the previous iteration, the efficacy determination module 308 may provide the training data sets from the group 322 (including the relabeled training data set 362 from the previous iteration) to the re-trained classification model 306 to obtain a first set of outputs, and may feed the training data sets from the group 324 (excluding the relabeled training data set 362 from the previous iteration) to the re-trained classification model 306 to obtain a second set of outputs. The efficacy determination module 308 may analyze the first set of outputs to determine a threshold value (e.g., a maximum output value, a minimum output value, etc.). The classification system may then analyze the second set of outputs to determine whether the re-trained classification model 306 has identified any additional training data sets within the group 324 that are mislabeled based on the threshold value. After identifying the one or more training data sets from the group 324 that have been mislabeled, the data preparation module 302 may relabel the one or more mislabeled data sets to the correct label.

In some embodiments, during each iteration, the efficacy determination module 308 may also calculate a pseudo F-measure (which can also be used as an efficacy score for determining an efficacy of the machine learning model in detecting mislabeled data) for the classification model 306 based on the outputs produced by the classification model 306. The efficacy determination module 308 may compare the pseudo F-measure calculated for the classification model 306 during the current iteration against the pseudo F-measure calculated for classification model 306 during the previous iteration. As the performance of the classification model 306 improves through the iterations of re-training, the pseudo F-measure calculated for the classification model 306 would also increase to reflect the improvement. In some embodiments, the efficacy determination module 308 may use the pseudo F-measure as an indicator for determining when to stop the iterative training of the classification model 306. For example, the efficacy determination module 308 may determine to stop the iterative process of training the classification model 306 when the increase of the pseudo F-measure (from the previous iteration to the current iteration) is below a threshold, indicating a lack of improvement to the classification model 306. As such, the efficacy determination module 308 may monitor the changes of the pseudo F-measure in each iteration, and may abort the iterative process of training the classification model 306 when the difference of pseudo F-measures between the consecutive iterations is below the threshold.

In a scenario where the increase of the pseudo F-measure exceeds the threshold (indicating a substantial improvement in the ability of the classification model 306 to detect mislabeled data sets) but no mislabeled data sets have been identified based on the threshold value, the efficacy determination module 308 of some embodiments may adjust the threshold value and determine if any mislabeled data sets can be identified based on the adjusted threshold value. For example, if the threshold value corresponds to a maximum output value, the efficacy determination module 308 may increase the threshold value (e.g., by 5%, by 10%, etc.). If the threshold value corresponds to a minimum output value, the efficacy determination module 308 may reduce the threshold value (e.g., by 5%, by 10%, etc.). In some embodiments, the efficacy determination module 308 may determine the amount of adjustment to the threshold value based on the amount of increase in the F-measure. For example, the efficacy determination module 308 may determine the amount of adjustment to the threshold value as a percentage (e.g., 80%, 100%, 120%, etc.) of the increase in the F-measure. In some embodiments, the efficacy determination module 308 may continue to adjust the threshold value until at least one mislabeled data set is identified.

Thus, the transaction processing module 132 may continue to perform the iteration process of re-training the classification model 306 until a termination event has occurred (e.g., the increase of the pseudo F-measure is below the threshold). When the iterative training process is complete, the transaction processing module 132 may deploy the classification model 306 for use in classifying transactions in a production environment. For example, as requests for processing new transactions are received by the service provider server 130 (e.g., from the user device 110 and/or the merchant server 120), the transaction processing module 132 may use the classification module 306, that has been trained using the techniques disclosed herein, to classify the new transactions, and may process the new transactions based on the classifications.

In the example illustrated above, the iterative training process was used to train a machine learning model (e.g., the classification model 306) configured to perform a binary classification. However, it is appreciated that the iterative training process can be used to train any other types of machine learning models, including machine learning models that perform non-binary classifications, and other prediction tasks.

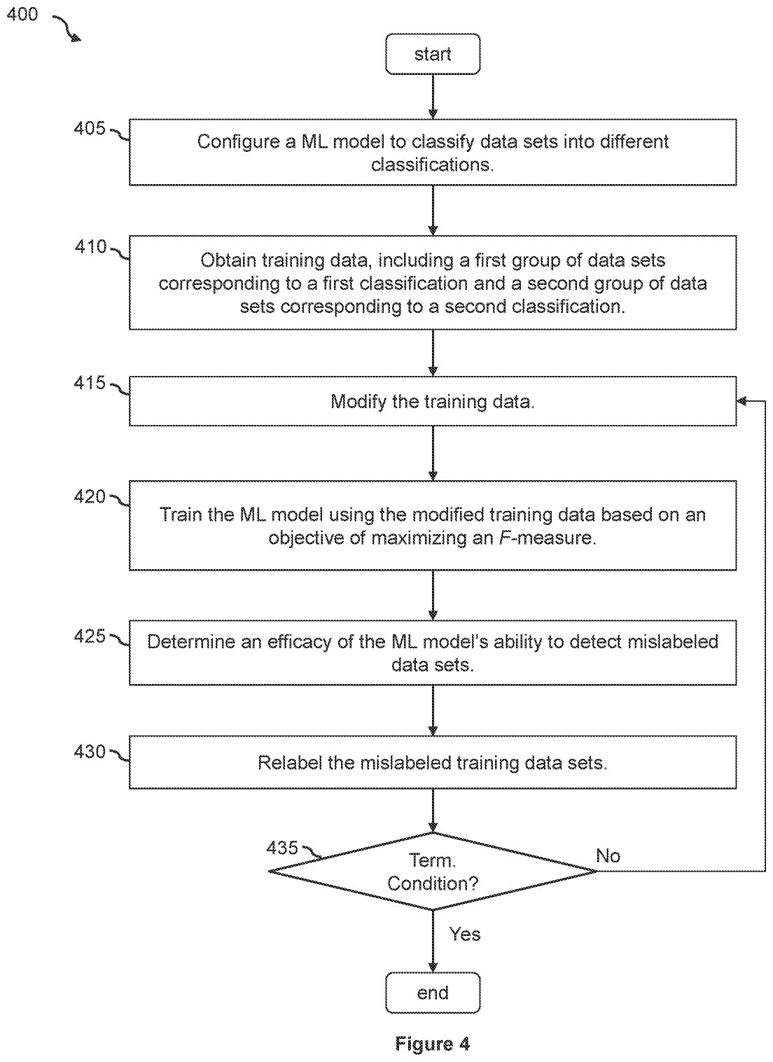

FIG. 4 illustrates a process 400 for training a machine learning model using the semi-supervised machine learning framework according to various embodiments of the disclosure. In some embodiments, at least a portion of the process 400 may be performed by the transaction processing module 132. The process 400 begins by configuring (at step 405) a machine learning model to classify data sets into different classifications. For example, the transaction processing module 132 may generate and/or configure one or more machine learning models for performing various tasks associated with processing transactions for the service provider server 130. The machine learning models may include the classification model 306 configured to classify transactions as fraudulent transactions or non-fraudulent transactions. The process may alternatively obtain or access (at step 405) an ML model previously configured to classify data sets into different classifications.

The process 400 then obtains (at step 410) training data, including a first group of data sets corresponding to a first classification and a second group of data sets corresponding to a second classification. For example, the data preparation module 302 may obtain transaction data corresponding to transactions that have been previously processed by the transaction processing module 132 (or other modules of the service provider server 130) from the accounts database 136. The data preparation module 302 may label each of the transaction based on known information about the transaction (e.g., whether a fraud report has been received from an end user, etc.). The data preparation module 302 may generate the training data 310 based on the labeled transactions. The training data 310 may include the group of training data sets 312 corresponding to transactions that are labeled as fraudulent and the group of training data sets 314 corresponding to transactions that are labeled as non-fraudulent.

The process 400 modifies (at step 415) the training data and trains (at step 420) the machine learning model using the modified training data based on an objecting of maximizing an F-measure. For example, the data preparation module 320 may modify the training data 310 to generate modified training data 320. The modification may include selecting one or more training data sets 326 from the group 312 and relabeling the one or more training data sets 326. As a result, the one or more training data sets 326 may be moved from the group 312 to the group 314. The training module 302 may use the modified training data 320 to train the classification model 306 based on an objective function that minimizes a within-group output variance and maximizes a between-group output variance.

The process then determines (at step 425) an efficacy of the machine learning model's ability to detect mislabeled data sets and relabels (at step 430) the mislabeled training data sets. For example, the efficacy determination module 308 may obtain a first set of outputs from the classification model 306 based on training data sets from the group 322, and obtain a second set of outputs from the classification model 306 based on training data sets from the group 324. In some embodiments, the efficacy determination module 308 may determine a threshold value based on the first set of outputs (e.g., a maximum output value, a minimum output value, etc.). The efficacy determination module 308 may then determine whether the classification model 306 has detected any mislabeled training data set in the group 324 based on the threshold value. Once a mislabeled training data set (e.g., the mislabeled training data set 362) is detected, the data preparation module 302 may relabel the mislabeled training data set 362 (e.g., from the non-fraudulent classification to the fraudulent classification). The data preparation module 302 may also transfer the relabeled training data set 362 from the group 324 to the group 314.

The process determines (at step 435) whether a termination condition is detected. If the termination condition is not detected, the process reverts back to the step 415 and iterates through the steps back to step 435. However, if the termination condition is detected, the process ends. For example, the transaction processing module 132 may use the F-measure as an indication for determining whether to terminate the iterative training process. The efficacy determination module 308 may compare the F-measure calculated for the classification model 306 during the current iteration against the F-measure calculated for the classification model 306 during the previous iteration. Since the difference (e.g., the increase) in the F-measure indicates how much the classification model 306 has improved over the iterations, the efficacy determination module 308 may determine that the training process is complete (to stop the iterative training process) when the difference is below a threshold (indicating that the improvement to the classification model 306 is no longer substantial from the last training iteration). On the other hand, if the difference between the F-measures is above the threshold (indicating that the improvement to the classification model 306 is substantial), the transaction processing module 132 may perform another iteration of re-training of the classification model 306.

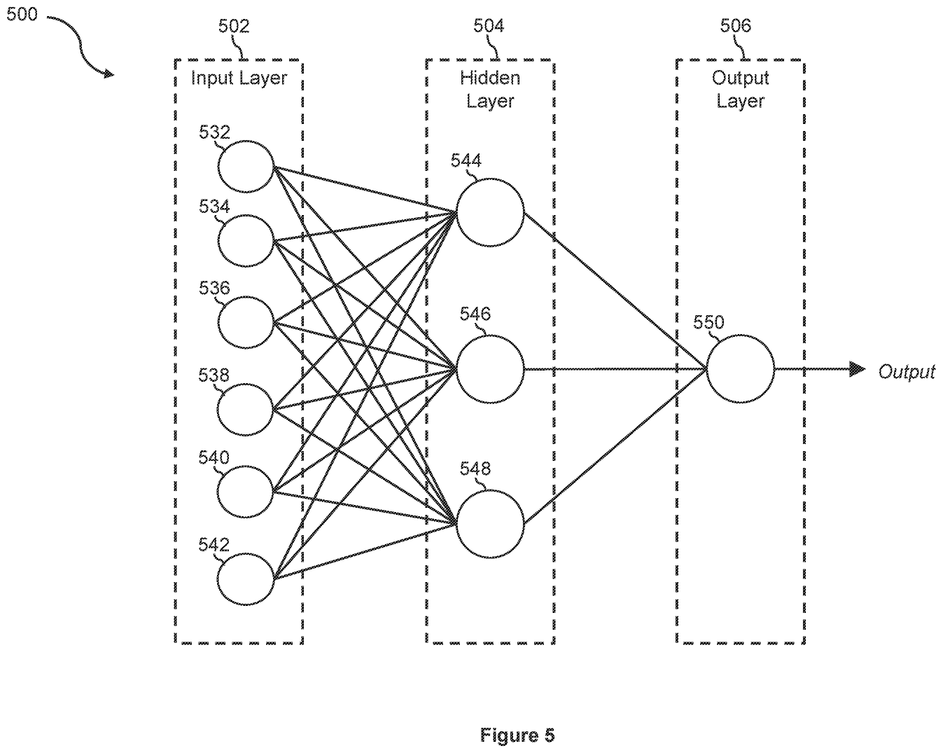

FIG. 5 illustrates an example artificial neural network 500 that may be used to implement any machine learning models (e.g., the classification model 306, etc.). As shown, the artificial neural network 500 includes three layers-an input layer 502, a hidden layer 504, and an output layer 506. Each of the layers 502, 504, and 506 may include one or more nodes. For example, the input layer 502 includes nodes 532, 534, 536, 538, 540, and 542, the hidden layer 504 includes nodes 544, 546, and 548, and the output layer 506 includes a node 550. In this example, each node in a layer is connected to every node in an adjacent layer. For example, the node 532 in the input layer 502 is connected to all of the nodes 544, 546, and 548 in the hidden layer 504. Similarly, the node 544 in the hidden layer is connected to all of the nodes 532, 534, 536, 538, 540, and 542 in the input layer 502 and the node 550 in the output layer 506. Although only one hidden layer is shown for the artificial neural network 500, it has been contemplated that the artificial neural network 500 used to implement any one of the computer-based models may include as many hidden layers as necessary.

In this example, the artificial neural network 500 receives a set of inputs and produces an output. Each node in the input layer 502 may correspond to a distinct input. For example, when the artificial neural network 500 is used to implement a classification model (e.g., the classification model 306, etc.), each node in the input layer 502 may correspond to an input feature associated with classifying a transaction into a fraudulent transaction or a non-fraudulent transaction.

In some embodiments, each of the nodes 544, 546, and 548 in the hidden layer 504 generates a representation, which may include a mathematical computation (or algorithm) that produces a value based on the input values received from the nodes 532, 534, 536, 538, 540, and 542. The mathematical computation may include assigning different weights (e.g., node weights, etc.) to each of the data values received from the nodes 532, 534, 536, 538, 540, and 542. The nodes 544, 546, and 548 may include different algorithms and/or different weights assigned to the data variables from the nodes 532, 534, 536, 538, 540, and 542 such that each of the nodes 544, 546, and 548 may produce a different value based on the same input values received from the nodes 532, 534, 536, 538, 540, and 542. In some embodiments, the weights that are initially assigned to the input values for each of the nodes 544, 546, and 548 may be randomly generated (e.g., using a computer randomizer). The values generated by the nodes 544, 546, and 548 may be used by the node 550 in the output layer 506 to produce an output value for the artificial neural network 500. When the artificial neural network 500 is used to implement the classification model 306 configured to determine a classification associated with a transaction, the output value produced by the artificial neural network 500 may indicate a classification (e.g., a classification score).

The artificial neural network 500 may be trained by using training data and one or more loss functions (also referred to as “objective functions” herein). By providing training data to the artificial neural network 500, the nodes 544, 546, and 548 in the hidden layer 504 may be trained (adjusted) based on the one or more loss functions such that an optimal output is produced in the output layer 506 to minimize the loss in the loss functions. By continuously providing different sets of training data, and penalizing the artificial neural network 500 when the output of the artificial neural network 500 is incorrect (as defined by the loss functions, etc.), the artificial neural network 500 (and specifically, the representations of the nodes in the hidden layer 504) may be trained (adjusted) to improve its performance in the respective tasks. Adjusting the artificial neural network 500 may include adjusting the weights associated with each node in the hidden layer 504.

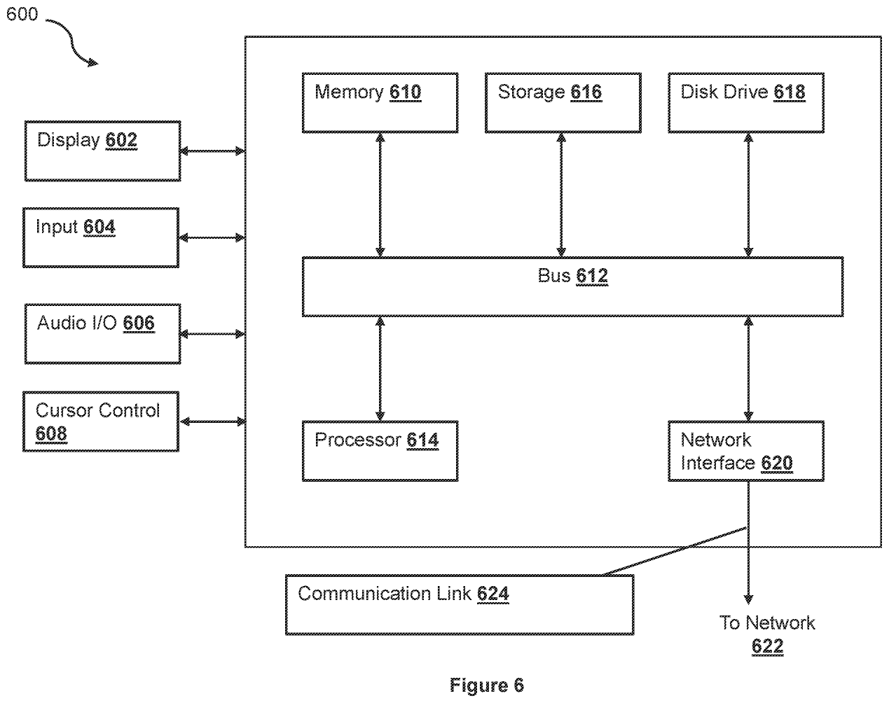

FIG. 6 is a block diagram of a computer system 600 suitable for implementing one or more embodiments of the present disclosure, including the service provider server 130, the merchant server 120, and the user device 110. In various implementations, the user device 110 may include a mobile cellular phone, personal computer (PC), laptop, wearable computing device, etc. adapted for wireless communication, and each of the service provider server 130 and the merchant server 120 may include a network computing device, such as a server. Thus, it should be appreciated that the devices 110, 120, and 130 may be implemented as the computer system 600 in a manner as follows.

The computer system 600 includes a bus 612 or other communication mechanism for communicating information data, signals, and information between various components of the computer system 600. The components include an input/output (I/O) component 604 that processes a user (i.e., sender, recipient, service provider) action, such as selecting keys from a keypad/keyboard, selecting one or more buttons or links, etc., and sends a corresponding signal to the bus 612. The I/O component 604 may also include an output component, such as a display 602 and a cursor control 608 (such as a keyboard, keypad, mouse, etc.). The display 602 may be configured to present a login page for logging into a user account or a checkout page for purchasing an item from a merchant. An optional audio input/output component 606 may also be included to allow a user to use voice for inputting information by converting audio signals. The audio I/O component 606 may allow the user to hear audio. A transceiver or network interface 620 transmits and receives signals between the computer system 600 and other devices, such as another user device, a merchant server, or a service provider server via a network 622. In one embodiment, the transmission is wireless, although other transmission mediums and methods may also be suitable. A processor 614, which can be a micro-controller, digital signal processor (DSP), or other processing component, processes these various signals, such as for display on the computer system 600 or transmission to other devices via a communication link 624. The processor 614 may also control transmission of information, such as cookies or IP addresses, to other devices.

The components of the computer system 600 also include a system memory component 610 (e.g., RAM), a static storage component 616 (e.g., ROM), and/or a disk drive 618 (e.g., a solid-state drive, a hard drive). The computer system 600 performs specific operations by the processor 614 and other components by executing one or more sequences of instructions contained in the system memory component 610. For example, the processor 614 can perform the machine learning model training functionalities described herein, for example, according to the process 400.

Logic may be encoded in a computer readable medium, which may refer to any medium that participates in providing instructions to the processor 614 for execution. Such a medium may take many forms, including but not limited to, non-volatile media, volatile media, and transmission media. In various implementations, non-volatile media includes optical or magnetic disks, volatile media includes dynamic memory, such as the system memory component 610, and transmission media includes coaxial cables, copper wire, and fiber optics, including wires that comprise the bus 612. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 600. In various other embodiments of the present disclosure, a plurality of computer systems 600 coupled by the communication link 624 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system, comprising:
a non-transitory memory; and
one or more hardware processors coupled with the non-transitory memory and configured to read instructions from the non-transitory memory to cause the system to perform operations comprising:
obtaining training data for training a machine learning model configured to classify data sets into a first classification or a second classification, wherein the training data comprises a first group of data sets and a second group of data sets, wherein each data set in the first group of data sets is labeled with the first classification, and wherein each data set in the second group of data sets is labeled with the second classification;
training the machine learning model using the training data;
obtaining, from the trained machine learning model, a first plurality of classification scores based on the first group of data sets and a second plurality of classification scores based on the second group of data sets;
modifying the first group of data sets and the second group of data sets based on the first plurality of classification scores and the second plurality of classification scores, wherein the modifying comprises relabeling at least one data set in the second group of data sets from the second classification to the first classification; and
re-training the machine learning model based on the modified first group of data sets and the modified second group of data sets.

2. The system of claim 1, wherein the training the machine learning model is based on an objective function that minimizes a within-group output variance and/or maximizes a between-group output variance of the machine learning model.

3. The system of claim 1, wherein the operations further comprise:
detecting that the at least one data set has been mislabeled based on the first plurality of classification scores and the second plurality of classification scores, wherein the modifying is based further on the detecting.

4. The system of claim 1, wherein the operations further comprise:
calculating a first value based on the first plurality of classification scores and the second plurality of classification scores, wherein the first value indicates an efficacy of the machine learning model in detecting mislabeled data sets; and
determining whether the first value is larger than a second value calculated during a previous training iteration of the machine learning model, and wherein the re-training the machine learning model is responsive to determining that the first value is larger than the second value by a threshold.

5. The system of claim 1, wherein the operations further comprise:
prior to the training the machine learning model, relabeling a first subset of data sets in the first group from the first classification to the second classification and moving the first subset of data sets from the first group to the second group.

6. The system of claim 5, wherein the operations further comprise randomly selecting the first subset of data sets from the first group of data sets.

7. The system of claim 1, wherein each data set in the first group of data sets and the second group of data sets corresponds to a transaction, wherein the first classification corresponds to a fraudulent classification, and wherein the second classification corresponds to a non-fraudulent classification.

8. A method, comprising:
dividing training data into a first set of training data associated with a first classification and a second set of training data associated with a second classification;
training a machine learning model using the training data;
obtaining, from the machine learning model, a plurality of classification scores based on the training data;
modifying the training data based on the plurality of classification scores; and
re-training the machine learning model using the modified training data.

9. The method of claim 8, wherein the modifying the training data comprises:
determining that a portion of the training data has been mislabeled based on the plurality of classification scores; and
relabeling the portion of the training data.

10. The method of claim 9, wherein the plurality of classification scores comprises a first set of classification scores obtained from the machine learning model based on the first set of training data, and wherein the method further comprises:
determining a threshold based on the first set of classification scores, wherein the determining that the portion of the training data has been mislabeled is based on the threshold.

11. The method of claim 10, wherein the threshold corresponds to at least one of a highest classification score or a lowest classification score in the first set of classification scores.

12. The method of claim 8, further comprising:
calculating an efficacy score representing an ability of the machine learning model in detecting mislabeled data sets, wherein the re-training the machine learning model is based on the efficacy score.

13. The method of claim 8, wherein the training the machine learning model is based on an objective function that minimizes a within-group output variance and/or maximizes a between-group output variance of the machine learning model.

14. The method of claim 8, further comprising:
prior to the training the machine learning model, converting a subset of training data in the first set of training data from the first classification to the second classification.

15. A non-transitory machine-readable medium having stored thereon machine-readable instructions executable to cause a machine to perform operations comprising:
obtaining training data, wherein the training data comprises a first group of data sets and a second group of data sets, wherein each data set in the first group of data sets is labeled with a first classification, and wherein each data set in the second group of data sets is labeled with a second classification;
training, using the training data, a machine learning model configured to classify data into the first classification or the second classification;
obtaining, from the trained machine learning model, a first plurality of outputs based on the first group of data sets and a second plurality of outputs based on the second group of data;
detecting at least one data set, from the second group of data sets, that has been mislabeled based on the first plurality of outputs and the second plurality of outputs; and
modifying the first group of data sets and the second group of data sets, wherein the modifying comprises relabeling the at least one data set from the second classification to the first classification.

16. The non-transitory machine-readable medium of claim 15, wherein the operations further comprise:
re-training the machine learning model using the modified first group of data sets and the modified second group of data sets.

17. The non-transitory machine-readable medium of claim 16, wherein the operations further comprise:
calculating a first value representing one or more output variances associated with the machine learning model; and
determining whether the first value is larger than a second value calculated during a previous training iteration of the machine learning model, and wherein the re-training the machine learning model is responsive to determining that the first value is larger than the second value by a threshold.

18. The non-transitory machine-readable medium of claim 15, wherein the training the machine learning model is based on an objective function that minimizes a within-group output variance and/or maximizes a between-group output variance of the machine learning model.

19. The non-transitory machine-readable medium of claim 15, wherein the operations further comprise:
prior to the training the machine learning model, relabeling a first subset of data sets in the first group from the first classification to the second classification and moving the first subset of data sets from the first group to the second group.

20. The non-transitory machine-readable medium of claim 19, wherein the operations further comprise randomly selecting the first subset of data sets from the first group of data sets.
